(19) United States
(12) Patent Application Publication
(10) Pub. No.: US 2015/0304686 A1
(43) Pub. Date: Oct. 22, 2015

(54) SYSTEMS AND METHODS FOR IMPROVING QUALITY OF COLOR VIDEO STREAMS

(71) Applicant: Matrixview Inc., Sunnyvale, CA (US)

(72) Inventor: Arvind Thiagarajan, San Jose, CA (US)

(21) Appl. No.: 14/691,510

(22) Filed: Apr. 20, 2015

Related U.S. Application Data
(63) Continuation-in-part of application No. 61/982,801, filed on Apr. 22, 2014.
(60) Provisional application No. 61/982,801, filed on Apr. 22, 2014.

(51) Int. Cl. H04N 19/80; H04N 19/147; H04N 19/117; H04N 19/159; H04N 19/86

(52) U.S. Cl. CPC H04N 19/80; H04N 19/159; H04N 19/86; H04N 19/117; H04N 19/147

(57) ABSTRACT

A computerized system and method for enhancing video images including preprocessing of the video images to substantially maintain video quality at lower bit rates. Color video images are preprocessed by separating the color images into video components and passing each of the separated video components through corresponding convolution filters thereby creating corresponding separate filtered video components. The filtered video components are recombined into filtered video images and can be de-blocked thereby causing edges of the filtered video image to become crispier. The bit rate can be optimized to reduce distortion caused by the preprocessing and any previous compression. Appropriate inter-frame or intra-frame rates can be selected for target display screen sizes.

### CROSS REFERENCE TO RELATED APPLICATIONS

This application claims the benefit of and is a continuation-in-part of co-pending U.S. provisional application no. 61/982,801, filed Apr. 22, 2014, of the same title, which application is incorporated in its entirety by this reference.

### BACKGROUND

The present invention relates to systems and methods for enhancing video at the same bit rate or same quality at lower bit rate. Currently video that is supposed to play in high definition on the internet is either played in high definition but requires too long to download or is actually played in standard definition. Users do become impatient and won't wait for the video to download when played in high definition on slower networks. Some internet sites will automatically decrease the definition so that the video buffers faster. In order to watch the high definition video, either the user must wait till the video is fully downloaded on a slow network or must accept watching the video in lower quality.

A similar problem applies to still images. High quality images require either a high speed network or reduction in quality in order for the user to access the information. Additionally high quality images can be very large files which can cause difficulty when sending through electronic mail.

It is therefore apparent that an urgent need exists for an enhancement and compression method that allows for transmission of high quality videos at a lower bit rate. This improved system and method enables a user to download and send higher quality videos and images at a lower bit rate. High definition videos can be downloaded faster and in higher quality than compared to present methods.

### SUMMARY

To achieve the foregoing and in accordance with the present invention, systems and methods for video enhancement is provided. In particular the systems and methods for video enhancement are achieved through applying preprocessing intelligent algorithms. These algorithms create a visually lossless quality which allows for the same video quality at lower bit rates. Each color image is separated according to the luminance/chrominance or MVU portions. Each of the three luminance/chrominance portions or MVU portion is sent through convolution filters which create the separate luminance/chrominance or MVU filter images. This portion of the video enhancement is called pre-processing.

After pre-processing, the video images are processed through three additional programs. The rate/distortion optimization removes distortion caused by the pre-processing and previous compression. The coder control allows the system to intelligently choose the inter/intra frame ration relative to the display screen. The motion analysis allows for comparing one image to another. The image is then sent through a de-blocking filter where the image is further enhanced by causing edges to become crisper. The last step of the intelligent video algorithm prepares the video image for compression. After all the processing video is then compressed using standard H.264 technology.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is a block diagram showing a system and method for enhancing and compressing video leading to improved visual quality, in accordance with some embodiment of the present invention;

FIG. 2 is a block diagram showing a system and method for the intelligent video algorithms, in accordance with some embodiment;

FIG. 3 is a block diagram showing a system and method for describing the preprocessing filter, in accordance with some embodiment;

FIG. 4 is a block diagram showing a system and method for describing the MVU processing of image color separation, in accordance with some embodiment;

FIG. 5 is a block diagram showing a system and method for describing the luminance/Y filter processing, in accordance with some embodiment;

FIG. 6 is a block diagram showing a system and method for describing the red-green/U filter processing, in accordance with some embodiment; and

FIG. 7 is a block diagram showing a system and method for describing the blue-yellow/V filter processing, in accordance with some embodiment.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well-known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to systems and methods for enhancing video quality and compressing videos. The invention allows for better visual quality with any CODEC for the same bit rates, and same visual quality at a lower bit-rate. The invention leads to improved compression performance for perceptually lossless video at lower bit rates.

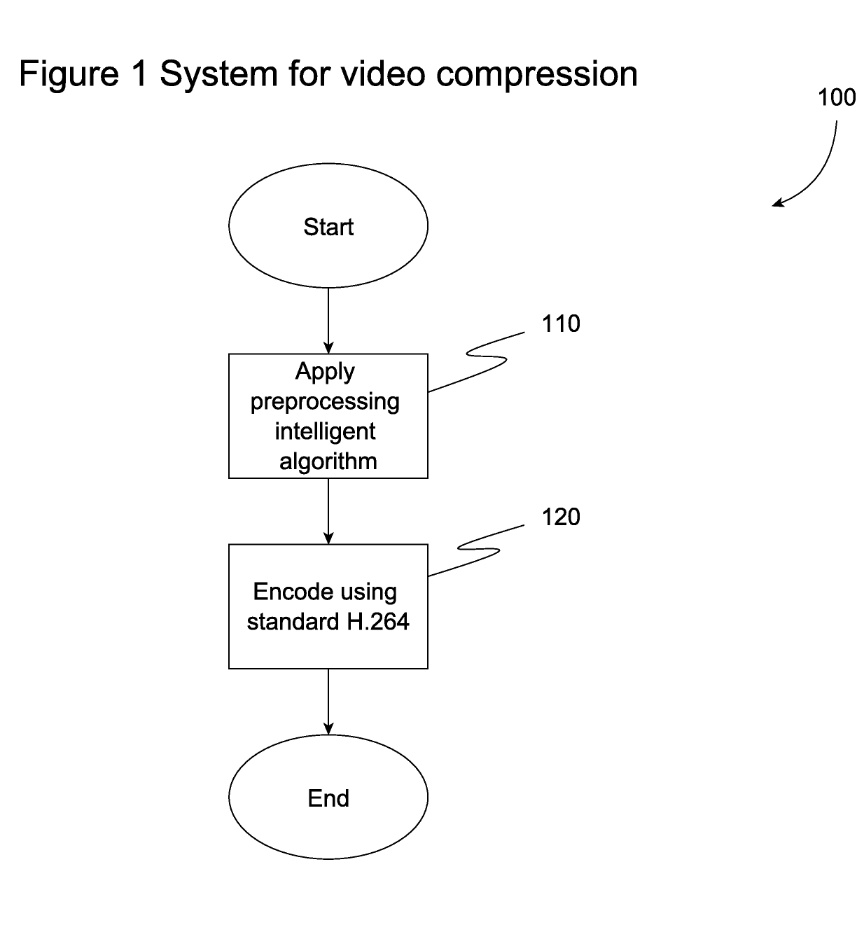

To facilitate discussion, FIG. 1 illustrates a process 100 for an exemplary system to enhance and compress video leading to improved visual quality at the same bit-rates. The process 100 contains two steps: applying preprocessing intelligent algorithms 110 and encoding using standard H.264 compression 120.

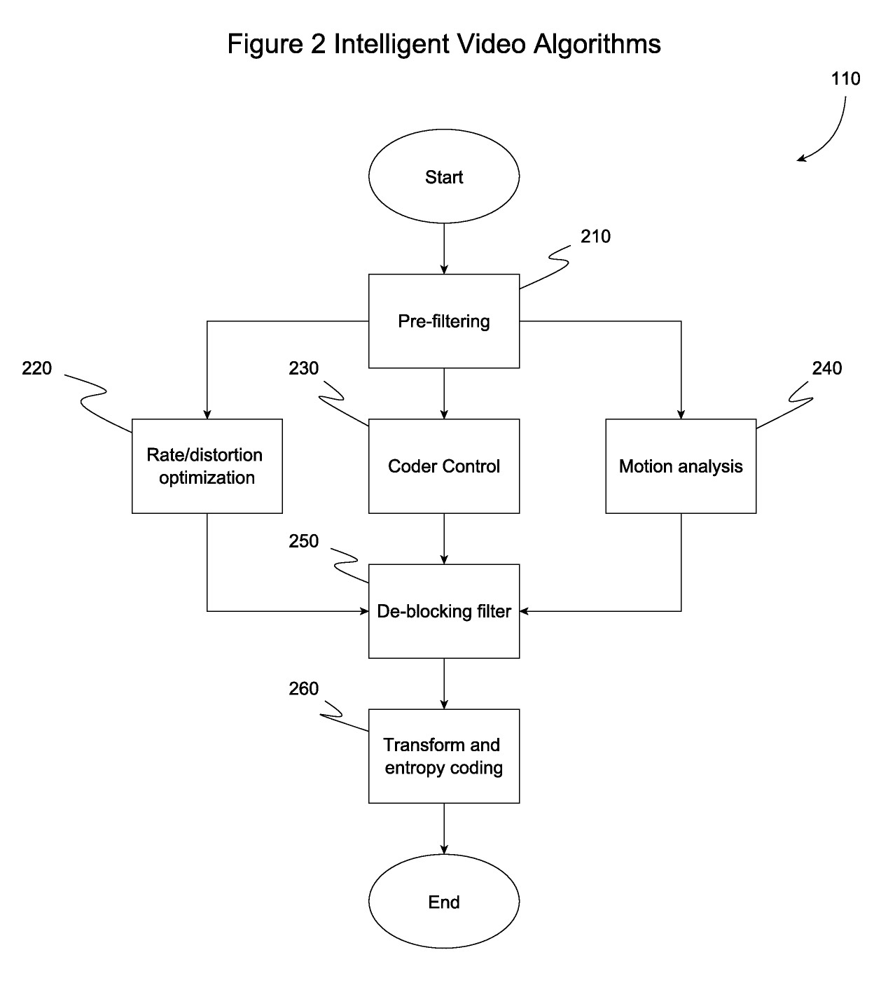

FIG. 2 is a block diagram detailing the intelligent video algorithms 110. The input video is sent through the pre-filtering 210 processing. Here the video is sent through spatial and temporal filtering for perceptually lossless compression. This pre-filtering 210 changes the video irreversibly. Moreover, the parameters of the pre-filtering 210 are chosen according to the display size. The video is then sent through three different processes: 1) rate distortion/optimization 220, 2) coder control 230, and 3) motion analysis 240. Rate distortion/optimization 220 occurs by determining what is the original signal and what is the distortion introduced through compression. The distortion that is introduced is removed to improved quality at lower bit rates. The rate/distortion optimization 220 of the quantization parameters is usually expressed in peak signal-to-noise ration. The coder control 230 is the process where the inter/intra frame is intelligently chosen between 4×4 to 16×16 to improve quality. The Choice of the Group of Pictures (GOP) structure reduces bit rate. Through Scene Cut Detection, the intra frame (I) is intelligently determined. The last process is motion analysis 240. The motion analysis 240 occurs by storing a maximum of 16 decoded frames and comparing the frames; however, only up to two decoded frames can be referenced for a given frame. Moreover, the motion analysis 240 smoothes tiles found in uniform looking areas. Thus the performance in motion analysis 240 is tuned by two offset values. After the three processes are performed, the video is sent through the de-blocking filter 250. The de-blocking filter 250 differentiates between natural and artificial block edges and then filters the latter. The de-blocking filter 250 also smoothes the tiles found in uniform looking areas. Performance is tuned by two offset values. Through segmentation techniques, blocks belonging to the same texture regions are identified and quantized similarly. The last step is transform and entropy coding 260. Transform and entropy coding 260 is a lossless data compression scheme that is independent of the specific characteristics of the medium.

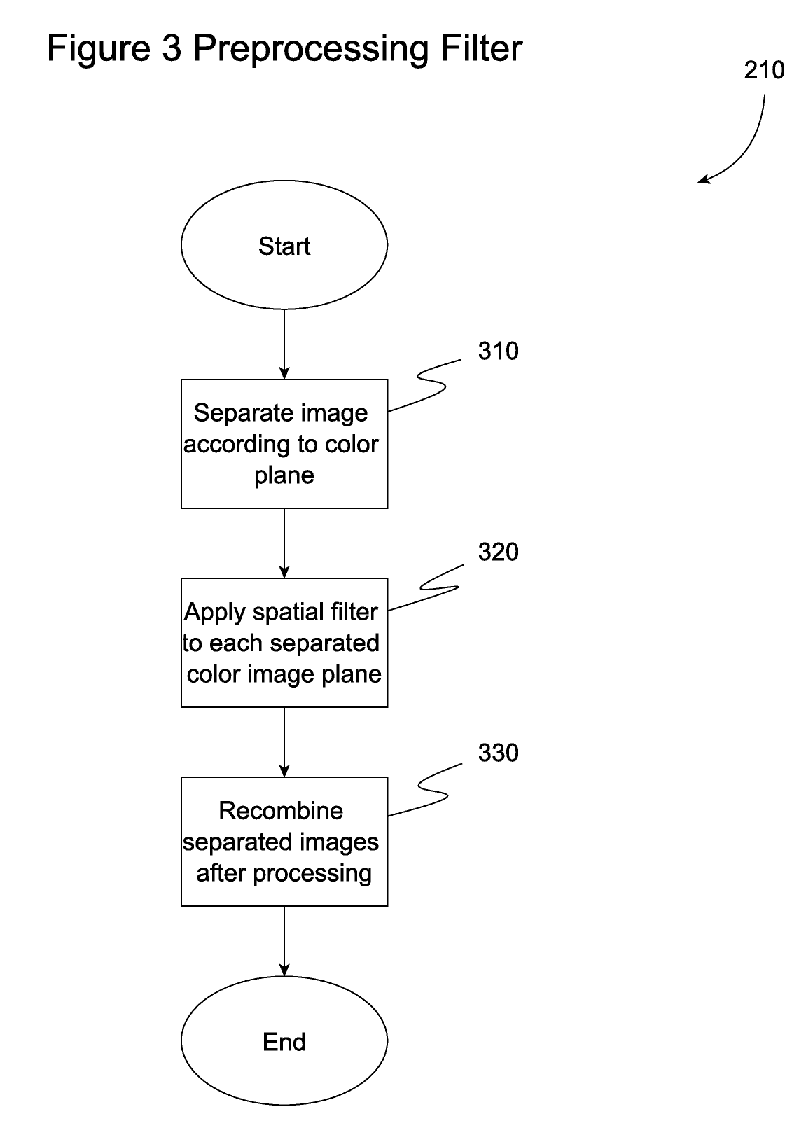

FIG. 3 is a block diagrams depicting the preprocessing filter 210. The preprocessing filter 210 occurs through spatial and temporal filtering for perceptually lossless compression. The first step of the preprocessing filter requires separating the image according to color planes 310. Then the spatial filters are applied to each of the separated color image planes 320. After the various spatial filters are applied the image planes are recombined 330 into a single image.

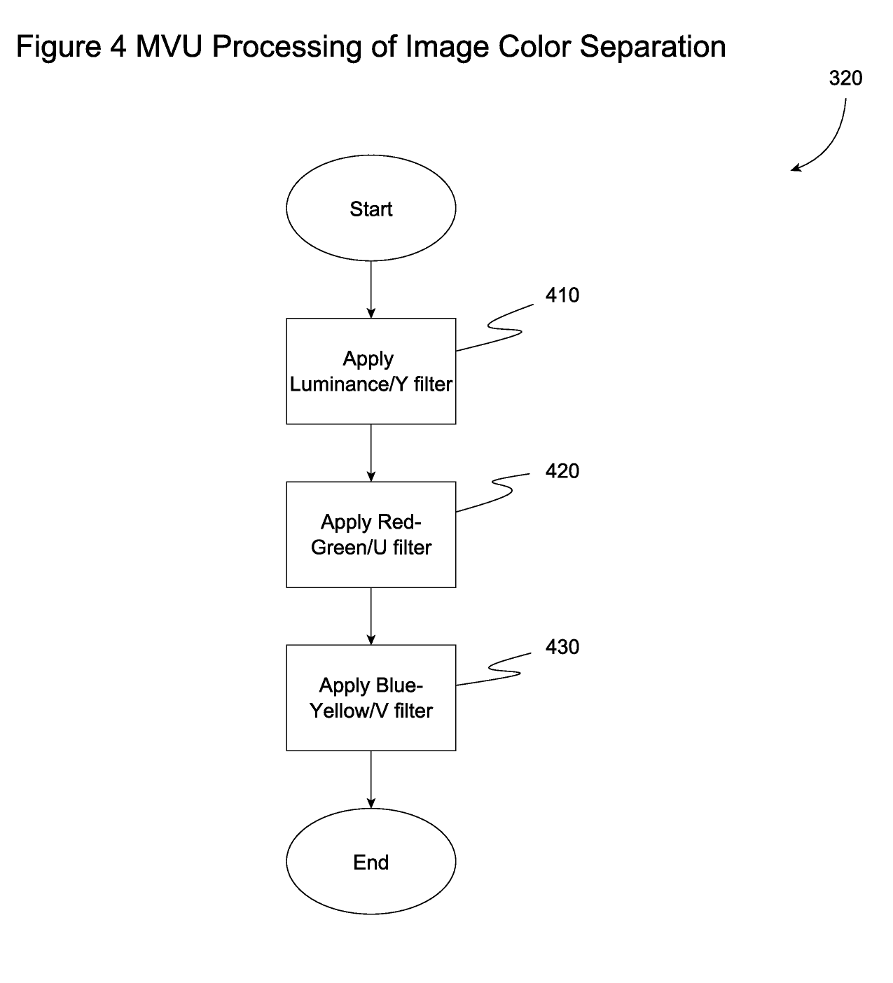

FIG. 4 is a block diagram depicting the process of applying the various spatial filters of MVU processing of image color separation 320. The MVU processing contains three different filters: 1) luminance/Y filter 410, 2) red-green/U filter 420, and 3) blue-yellow/V filter 430. The three filters are applied in the specific order stated for optimum visual enhancement. Moreover, each filter contains a vertical and horizontal vector. The vertical vector is obtained by removing the sign from the horizontal vector (i.e., V=|H|). Each vector contains 15 signed floating point elements and is symmetrical about the middle element (i.e., 0-6 are the same as 8-14 in reverse order).

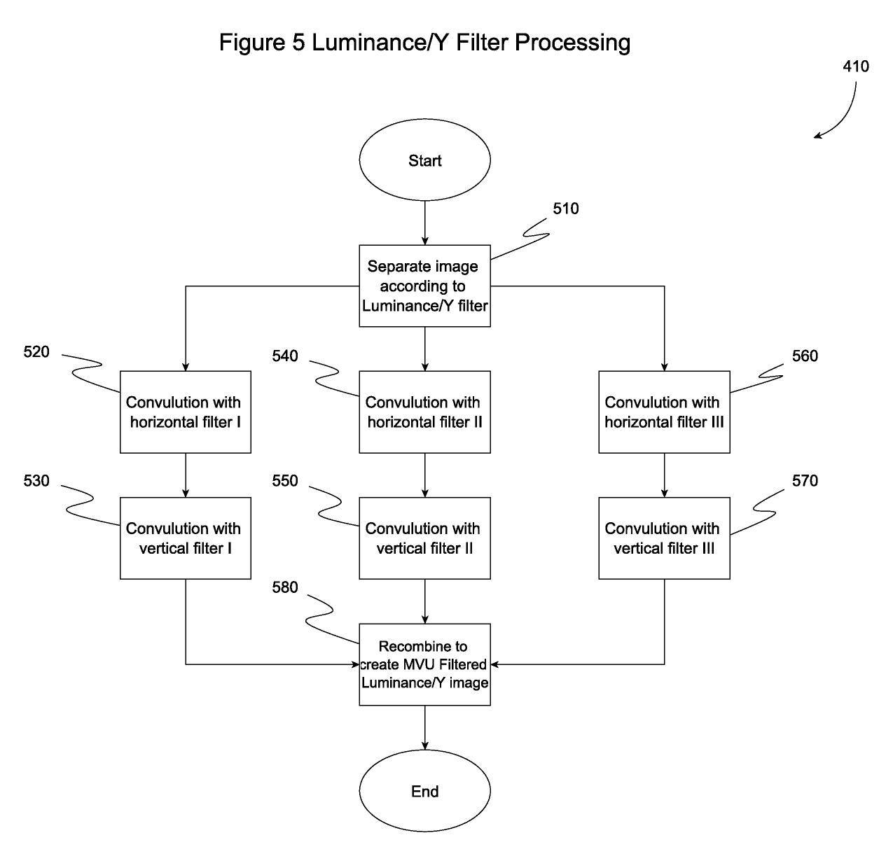

FIG. 5 is a block diagram depicting the luminance/Y filter processing 410. The luminance/Y filter represents the brightness in an image (also known as the black and white portion of the image). The luminance Y/filter separated image is then sent through three different convolution filters 510. Each convolution filter has a horizontal filter 520, 540, and 560 and a vertical filter 530, 550, and 570. After each of the convolutions has been applied in the specific order stated, the images are recombined to create the MVU filtered luminance/Y image 580.

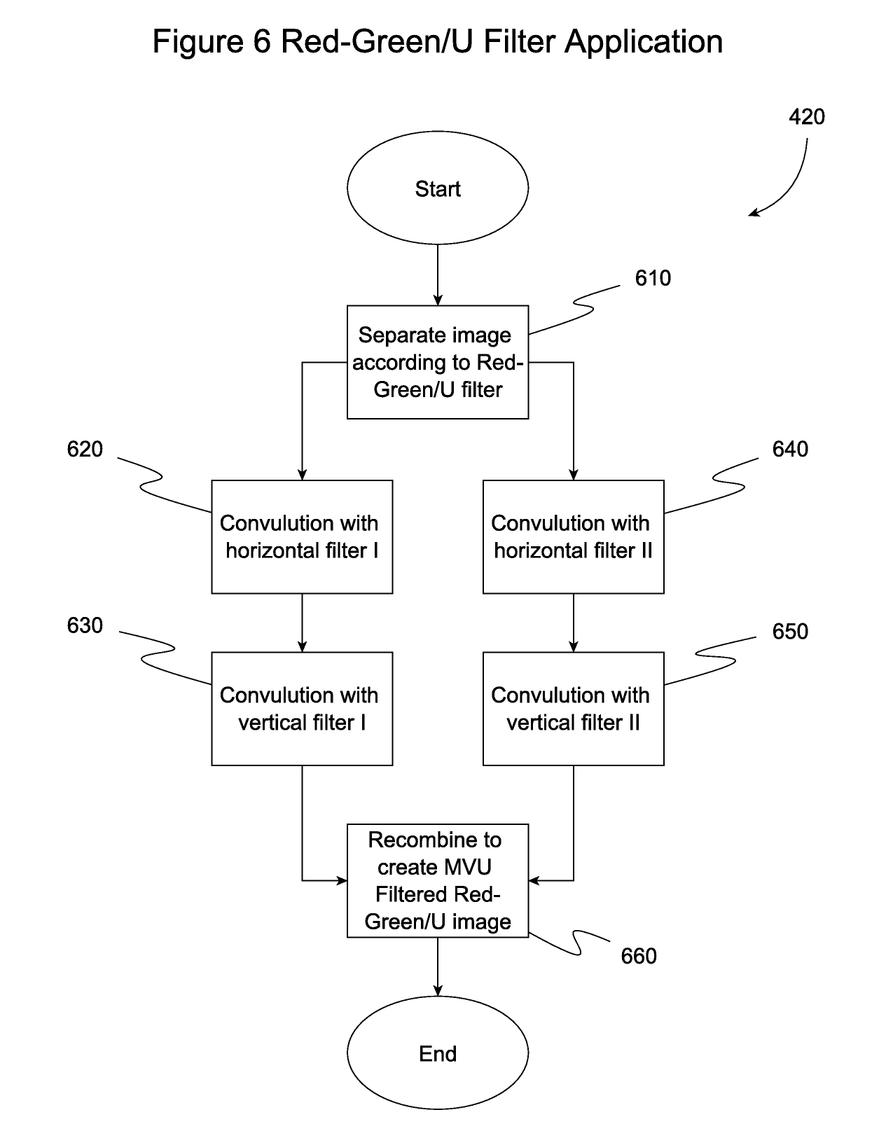

FIG. 6 is a block diagram depicting the red-green/U filter processing 420. The red-green/U filter represents one of the color difference components of chrominance. The red-green/U filter separated image is then sent through two different convolution filters 610. Each convolution filter has a horizontal filter 620 and 640 and a vertical filter 630 and 650. After each of the convolutions has been applied in the specific order stated, the images are recombined to create the MVU filtered red-green/U image 660.

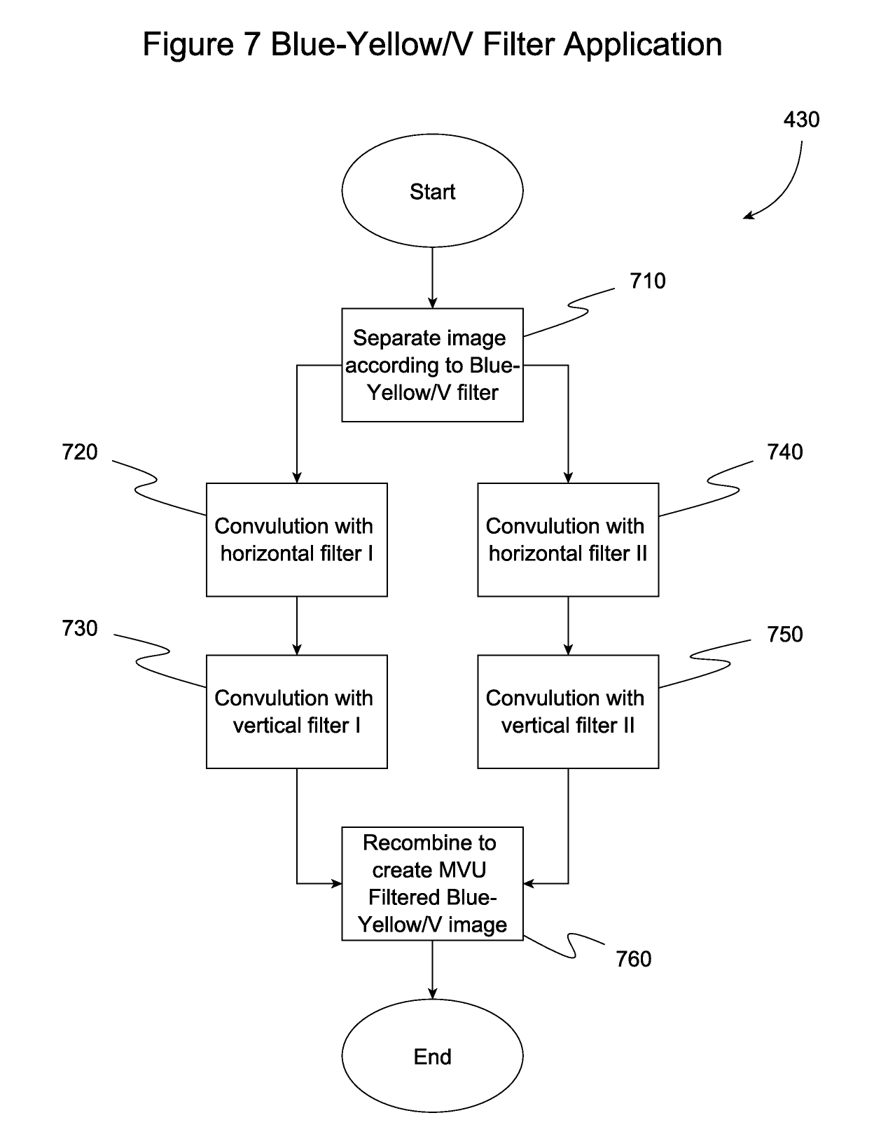

FIG. 7 is a block diagram depicting the blue-yellow/V filter processing 430. The blue-yellow/V filter represents one of the color difference components of chrominance. The blue-yellow/V filter separated image is then sent through two different convolution filters 710. Each convolution filter has a horizontal filter 720 and 740 and a vertical filter 730 and 750. After each of the convolutions has been applied in the specific order stated, the images are recombined to create the MVU filtered blue-yellow/V image 760.

In sum, the present invention provides a system and methods for enhancing video quality and compressing videos. The advantages of such a system include the ability to present video with higher quality at same bit rate, as well as the same quality of video at lower bit rates.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

1. A computerized method for enhancing video images including preprocessing the video images to substantially maintain video quality at lower bit rates, the method comprising:
preprocessing a color image by separating the color image into at least three video components, and passing each of the separated video components through corresponding convolution filters thereby creating corresponding separate filtered video components;
recombining the filtered video components into a filtered video image;
optimizing a bit rate thereby reducing distortion caused by the preprocessing and any previous compression of the color image;
selecting an appropriate inter-frame rate or intra-frame rate relative to a target display screen size;
motion analyzing the filtered video image by comparing the filtered video image to another video image;
de-blocking the filtered video image thereby causing edges of the filtered video image to become crisper; and
compressing the filtered video image using a standard compression algorithm.

2. The method of claim 1 wherein the video components include at least a luminance component and a chrominance component.

3. The method of claim 1 wherein the video components include MVU portions.

4. A computerized method for enhancing video images including preprocessing the video images to substantially maintain video quality at lower bit rates, the method comprising:
preprocessing a color image by separating the color image into at least two video components, and passing each of the separated video components through corresponding convolution filters thereby creating corresponding separate filtered video components;
recombining the filtered video components into a filtered video image;
optimizing a bit rate thereby reducing distortion caused by the preprocessing and any previous compression of the color image; and
compressing the filtered video image using a standard compression algorithm.
